(19) United States
(12) Patent Application Publication
(10) Pub. No.: US 2002/0143603 A1
(43) Pub. Date: Oct. 3, 2002

(54) Automated and optimized mass customization of direct marketing materials

(75) Inventor: Bruce Wayne Moore, Coppell, TX (US)

Correspondence Address: Gregory M. Doudnikoff, IBM Corporation T81/503, PO Box 12195, Research Triangle Park, NC, 27709, US

(73) Assignee: International Business Machines Corporation, Armonk, NY (US)

(21) Appl. No.: 09/766,357

(22) Filed: Jan. 19, 2001

(51) Int. Cl. G06F 17/60

(52) U.S. Cl. 705/10; 707/517

(57) ABSTRACT

A method for customizing direct marketing materials is provided. This method comprises developing models to predict customer purchases and then scoring potential customers for each predictive model. Next, specific layout areas are determined as well as where particular products may be placed in the layout. In one embodiment, preference multipliers are used to determine the increased likelihood of a product being purchased depending on its location in the layout (i.e. front cover). An optimization model is then used to customize the layout for potential customers, whether it be for a niche market or individual customers. The customized layout is only printed and sent if the expected profits exceed the production costs of the materials.

### BACKGROUND OF THE INVENTION

1. Technical Field

The present invention relates to network computing. More specifically, the present invention relates to customizing direct marketing materials for customers.

2. Description of Related Art

Direct marketers are constantly seeking improved methods for effectively targeting their advertisements to potential customers. Efforts are increasingly focused on moving closer to “one-to-one” marketing, or mass customized marketing materials, in which marketing materials are tailored to the tastes and buying habits of particular individuals and niche markets.

Unfortunately, it is very labor intensive to define direct mailers or web presentations for an individual customer. A key ingredient to customized marketing is data mining, which involves exploring detailed business transactions to uncover patterns and relationships within business activity and history. The process usually demands filtering through massive amounts of data and can be done manually or with programs that analyze the data automatically.

When marketers adopt the combination of data mining and one-to-one customized printing, they are faced with two new business processes: identifying what products to offer to each of the niche markets (or individuals), and designing graphic layouts for each niche (or individual).

Marketing and graphics labor availability will limit the number of niche markets (or individuals) that can be addressed, and will present a serious problem as marketers attempt to approach one-to-one marketing. Therefore, it would be desirable to have a method for automating these two business processes in order to increase the number of customized mailings without increasing the required staff support.

### SUMMARY OF THE INVENTION

The present invention provides a method for customizing direct marketing materials. This method comprises developing models to predict customer purchases and then scoring potential customers for each predictive model. Next, specific layout areas are determined as well as where particular products may be placed in the layout. In one embodiment, preference multipliers are used to determine the increased likelihood of a product being purchased depending on its location in the layout (i.e. front cover).

An optimization model is then used to customize the layout for potential customers, whether it be for a niche market or individual customers. The customized layout is only printed and sent if the expected profits exceed the production costs of the materials.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server, such as server in accordance with a preferred embodiment of the present invention;

FIG. 3 depicts a block diagram illustrating a data processing system in which the present invention may be implemented;

FIG. 4 depicts a flowchart illustrating a method for automated and mass customization of marketing materials in accordance with the present invention;

FIG. 5 depicts a diagram illustrating a grid layout in accordance with the present invention;

FIG. 6 depicts a flow diagram illustrating the transportation optimization model in accordance with the present invention;

FIG. 7 depicts a flow diagram illustrating the network optimization model in accordance with the present invention; and

FIG. 8 depicts a flow diagram illustrating the generalized network optimization model in accordance with the present invention.

### DETAILED DESCRIPTION OF THE PREFERRED EMBODIMENT

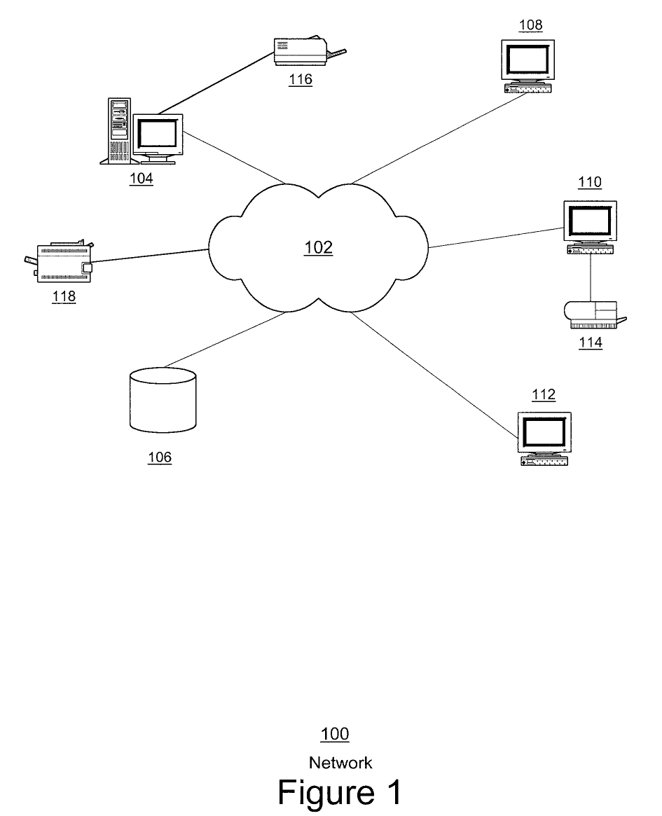

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

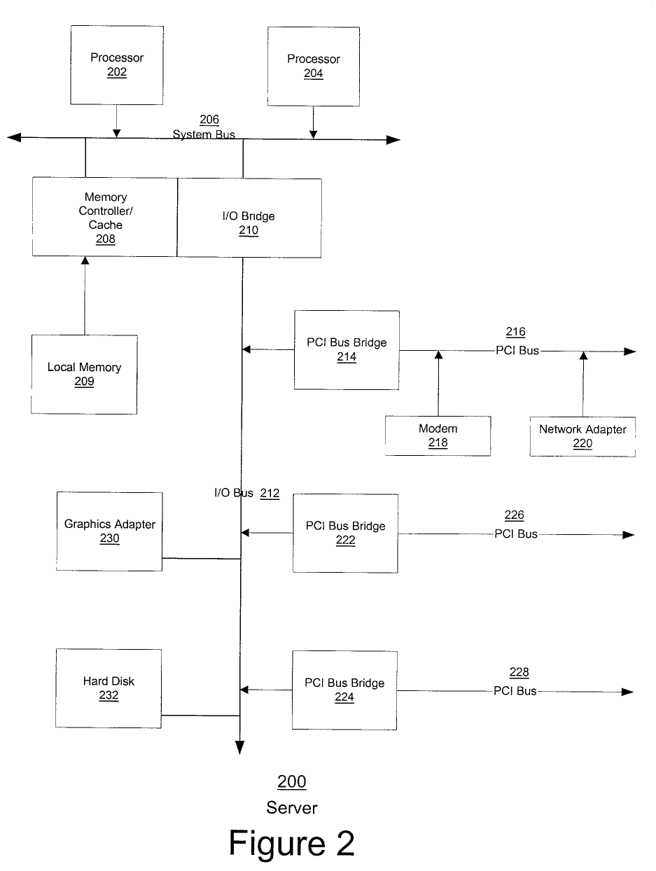

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

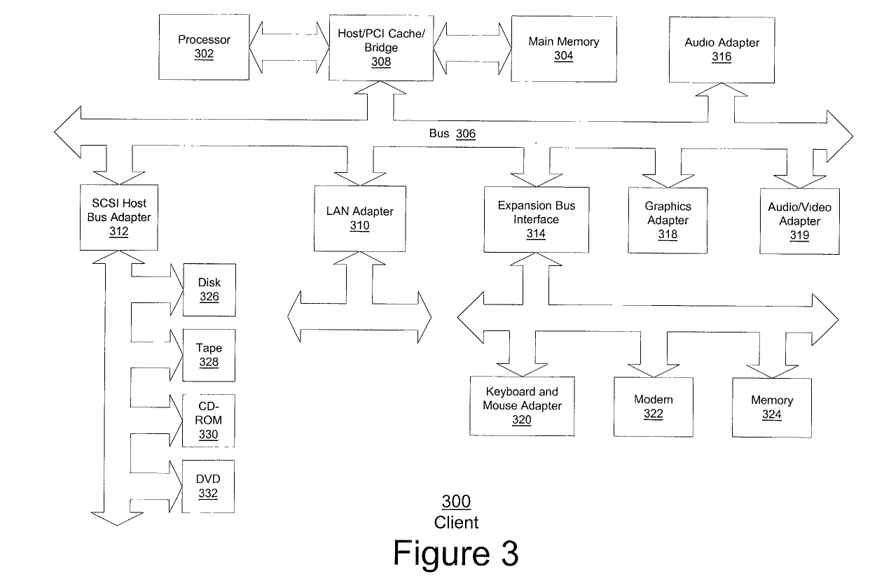

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

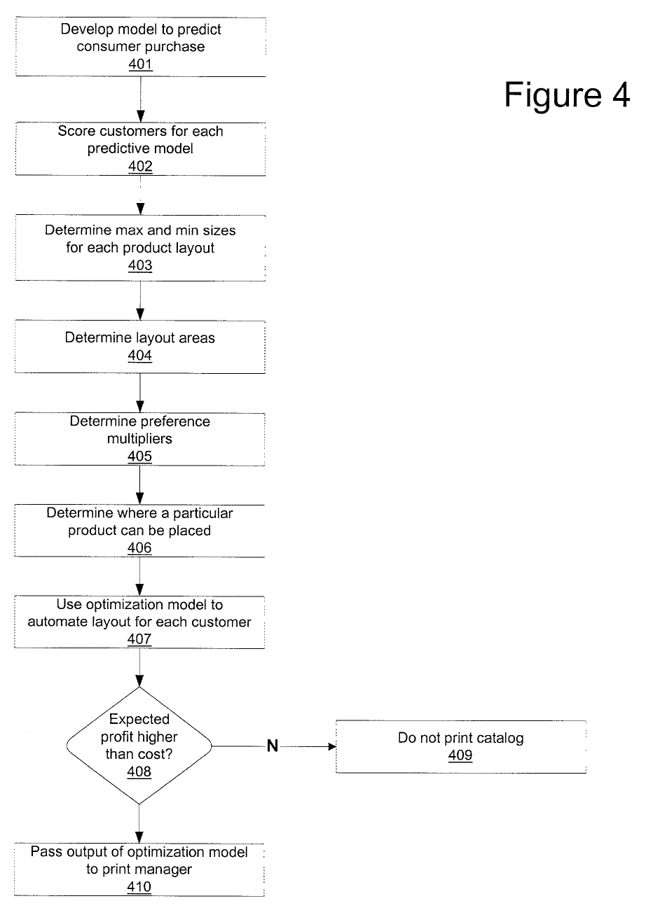

Referring now to FIG. 4, a flowchart illustrating a method for automated and mass customization of marketing materials is depicted in accordance with the present invention. The process begins with the development of a model to predict whether or not a consumer will purchase a particular product (step 401). This step would be performed by a marketing and data mining group. The data mining could be performed using a program such as Intelligent Miner and possibly a custom data mining program to run Intelligent Miner in batch to generate response models for each product. The model might provide the probability that a customer would buy a particular product or would respond to a particular marketing approach. The next step would be to score all customers for each predictive model (step 402). This step could be performed by an Information Technology (IT) or data mining group.

The next step requires the graphics design team to determine the minimum and maximum sizes for each product layout (step 403). From there, the team must then determine actual layout areas and the size of each area (step 404).

The graphics design team and data mining group must then develop a preference multiplier for each layout area (step 405). This might be done using a test mailing, although initial mailings might have preferences chosen by expert designers. An example of a preference multiplier would be putting a product on the cover and getting 25% increase in the likelihood that the product will be purchased. The preference multiplier would then be 1.25.

The graphics design team can then determine the layout areas where a particular product can be placed (step 406). This determination could be made using the sizes of product layouts, the sizes of layout areas and the suitability of a product for a layout area (i.e. cover).

A custom application would need to be provided to perform steps 403, 404 and 406 and to enter this information into a database. The custom user interface would update a Product Layout table with products numbers, the graphic/text file name to be used by InfoPrint Manager, and maximum and minimum size. A Layout Exclusion table would be updated with the product number and the layout area where the product cannot be printed. The application would also update a Layout Area table with layout area numbers, preference multipliers and layout area sizes.

After making the determinations above, the IT group can then use one of the optimization models described below to automate the creation of a layout that will maximize the expected profit for each customer (step 407). A custom application would generate a model and then run it for each customer. The model would be based on Product Layout, Layout exclusion, Layout Area and Customer Score. A program such as, for example, IBM Optimization Subroutine Library could solve the model and generate an output file that can be read by InfoPrint Manager.

It must then be determined if the expected profit from a particular customer is higher than the production cost of the catalog (step 408). If the expected profits do not exceed the production cost, the catalog is not printed and sent to the customer (step 409). If the expected profits do exceed the production costs, then the output of the optimization model is passed on to a print manager for printing (step 410). An application such as, for example, InfoPrint Manager could be used for this function.

The following sections describe three optimization models that could be used to automate and optimize mass customization. The first model is the simplest, and is the recommended model. The other two models are presented as reference material. They remove restrictions used in the simple mode, but require greater computation and may be less reliable. The models use graphic descriptions of networks (rather than equations) in order to make them easier to read.

A “grid” layout system is frequently used in graphic design. A page is divided into grids, with each design element occupying one or more grids. In the optimization model, a particular product might use a single grid location, or might use a collection of contiguous grid locations. The different models presented offer different levels of flexibility for layouts, with increasing processing time for more complex layouts.

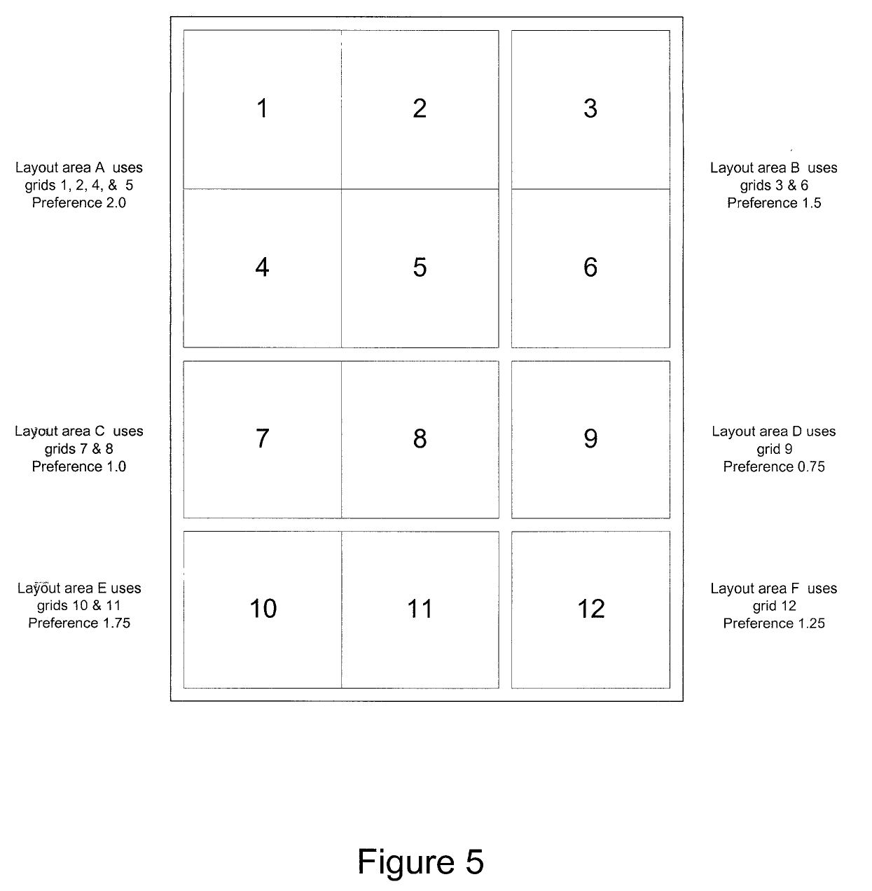

Referring to FIG. 5, a diagram illustrating a grid layout is depicted in accordance with the present invention. The grid layout has three grids horizontally and four grids vertically, resulting in 12 grid locations. In this example, the 12 grid locations have been assigned to six layout areas A-F, as illustrated. FIG. 5 shows how the layout areas are mapped to the grid locations, and gives example preference factors for each location.

The optimization models are of the form:

Max cx

Subject to

Ax=b

x>=0

Wherein c is the vector of costs for each arc, x is the column vector of arc flows (1 if the layout area is used, 0 if the layout area is not used), A is a node-arc incidence matrix, and b is the column vector of supply and demand for each node in the network.

The c vector is composed of the costs (profits) associated with using an arc in the network.

The recommended optimization model is the transportation model. This model is the simplest, and probably the fastest of the possible models, but is also the most restrictive in layout flexibility because there is no overlap of locations.

The table below is an approximation of a grid layout system.

TABLE 1

| | | | |
|---|---|---|---|
| 1 | 2 | 3 | 4 |
| 5 | 6 | 7 | 8 |
| 9 | 10 | 11 | 12 |
| 13 | 14 | 15 | 16 |

The following table lists an example of layout locations that the transportation model would support. Note that none of the possible layout locations overlap. The catalog sent to each customer would have the same “look”, based upon the layout.

TABLE 2

| Layout Location | Grids |
|---|---|
| A | 1, 2, 3, 5, 6, 7 |
| B | 4, 8 |
| C | 9, 13 |
| D | 10, 11, 12, 14, 15, 16 |

This model could be implemented using software such as, for example, IBM Optimization Subroutine Library using the network solver (“ekknslv”). The model could also be solved with a specialized solver for transportation models. The following table illustrates the relationship between model characteristics and layout design.

TABLE 3

| | | Upper Bound on | Upper Bound on |
|---|---|---|---|
| | | Size for 1000 | Size for 100 |
| Model | | products and 25 | products and 25 |
| Characteristics | Formula | locations | locations |
| Number of rows | I + J + 1 | 1,026 | 126 |
| Upper bound on | I * (J + 1) | 26,000 | 2,600 |
| number of | | | |
| columns | | | |
| Upper bound on | I * J | 25,000 | 2,500 |
| nonzero | | | |
| objective | | | |
| function | | | |
| entries | | | |

The variables and constants in the above table are defined below:
I is the number of products;
J is the number of layout locations; and
1 is the unused node

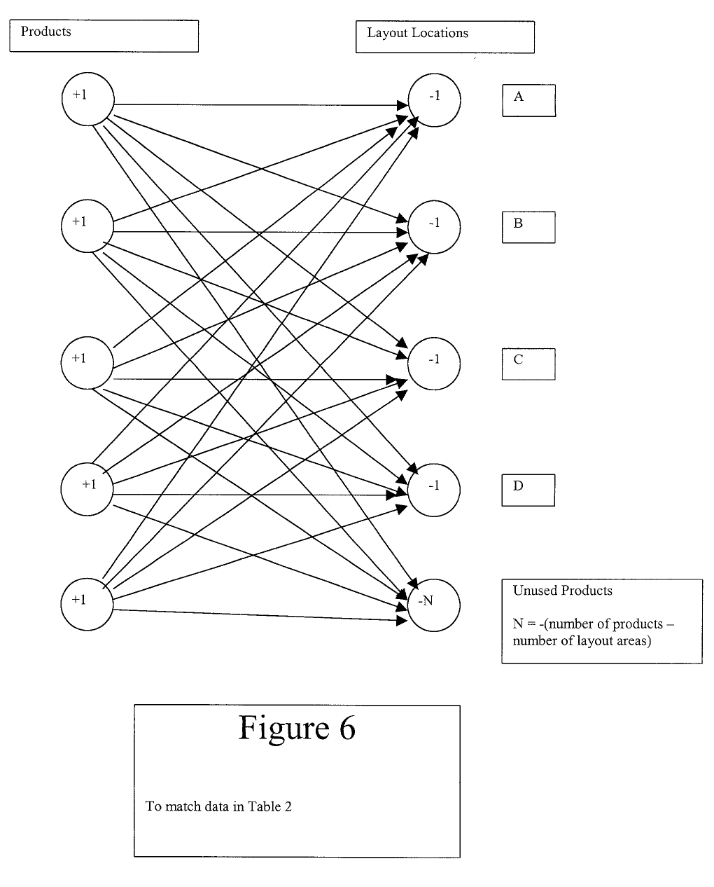

Referring to FIG. 6, a flow diagram illustrating the transportation model is depicted in accordance with the present invention. Each product node has a supply of 1, and each layout location has a demand of −1. The products flow to the location along the route that maximizes profit. No more than one product can flow to a particular layout location. Products that are not selected would flow to the unused location, as indicated. The cost for each product-to-layout location arc in the network is:

(probability of product purchase)×(profit per purchase)×(preference of location)

Moving on to another optimization model, customers wishing to use more flexible layouts could use a more complex network model where layout locations overlap to a limited extent. This would result in some unused space, and might result in unbalanced layouts.

The network model would use the same grid layout system as illustrated in Table 1. Assuming the grid layout in Table 1, the following table shows an example of layout locations that the network model could use.

TABLE 4

| | | | Overlap Node |
|---|---|---|---|
| Layout | | Overlap | Represents |
| Location | Grids | Location | Grid |
| A | 1, 2, 3, 5, 6, 7 | B | 3, 7 |
| B | 3, 7, 4, 8 | A | 3, 7 |
| C | 9, 10, 11, 13, 14, 15 | D | 11, 15 |
| D | 11, 12, 15, 16 | C | 11, 15 |

One problem with this model is that it will result in unused space:

If location A is used, location B will not be used. Grids 4 and 8 would not be used.

If location B is used, location A will not be used.

Grids 1, 2, 5 and 6 would not be used.

If location C is used, location D will not be used. Grids 12 and 16 would not be used.

If location D us used, location C will not be used. Grids 9, 10, 13 and 14 would not be used.

This model uses a pure network with a single +1 and a single −1 entry the column for each arc. Like the first model, the present one could be solved using the IBM Optimization Subroutine Library network solver (ekknslv). The following table illustrates the relationship between model characteristics and layout design.

TABLE 5

| | | Upper Bound on | Upper Bound on |
|---|---|---|---|
| | | Size for 1000 | Size for 1000 |
| Model | | products and 25 | products and 25 |
| Charac- | | locations with | locations with |
| teristics | Formula | 5 overlaps | 5 overlaps |
| Number of | I + J + L + 1 | 1,031 | 131 |
| rows | | | |
| Upper bound | I * (J + 1) + J * L | 26,125 | 2,725 |
| on number of | | | |
| columns | | | |
| Upper bound | I * J | 25,000 | 2,500 |
| on nonzero | | | |
| objective | | | |
| function | | | |
| entries | | | |

The variables and constants in the above table are the same as in Table 3, with L representing the number of overlaps.

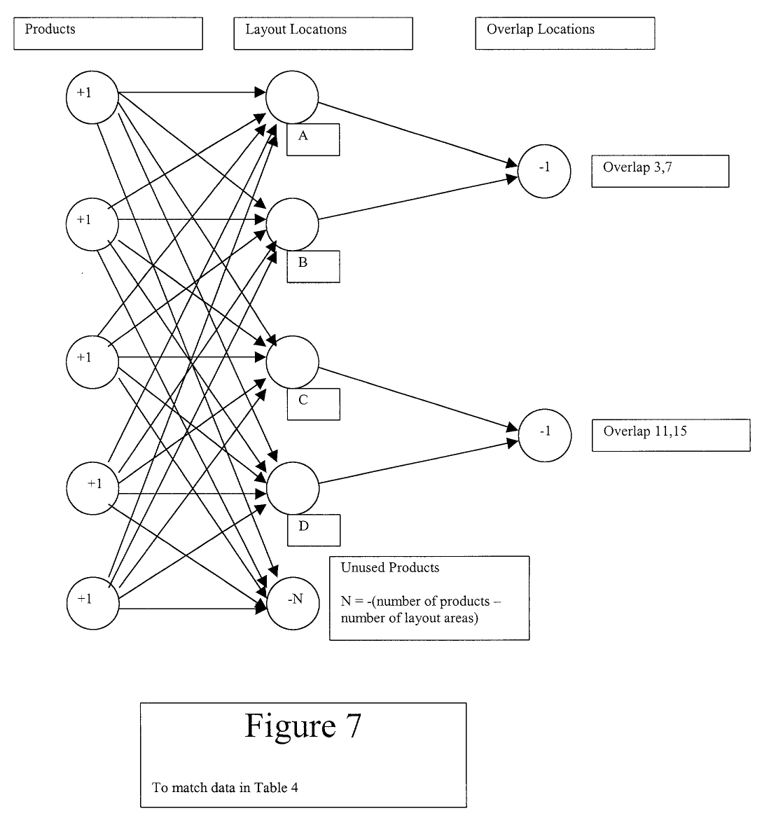

Referring now to FIG. 7, a flow diagram illustrating the network model is depicted in accordance with the present invention. Each product node has a supply of 1, and each overlap location has a demand of −1. The products flow to the location along the route that maximizes profit. No more than one product can flow to a particular layout (and overlap) location. Products that are not selected would flow to the unused location. The cost for each product-to-layout location arc in the network is:

(probability of product purchase)×(profit per purchase)×(preference of location)

The cost for each layout location-to-overlap is 0. The arc costs have been omitted from FIGS. 7 to improve the clarity of the figure.

The third possible optimization model is a generalized network model. This model is the most flexible, but is likely to be the slowest, and may not solve properly in some or all cases. It would require using one of the previous models as a backup in the code. However, there are two benefits to this model. The first is more flexible layouts where layout locations overlap. This model would not result in any unused space. The second benefit is the use of conditional profits, such as, for example, the likelihood of purchasing an extended warranty with a product. This feature is not shown for sake of simplicity.

Again, assuming the grid layout system from Table 1, the following table shows an example of layout locations that the generalized network model might use.

TABLE 6

| Layout Location | Grids | Overlap Location |
|---|---|---|
| A | 1, 5, 2, 6, 3, 7 | B, E, F |
| B | 1, 5, 2, 6 | B, C, F |
| C | 1, 5 | A |
| D | 4, 8 | D |
| E | 3, 7, 4, 8 | A, D, F |
| F | 2, 6, 3, 7, 4, 8 | A, B, E |

This model uses a generalized network. This model could be solved with the IBM Optimization Subroutine Library's linear program solver (ekksslv), or a third party generalized network solver. In the event that this model does not produce an integer solution, the software would need to either revert to one of the previous models, use a heuristic to resolve the layout problems, or use the mixed integer program solver (ekkmslv). The following table illustrates the relationship between model characteristics and layout design.

TABLE 7

| | | Size for 1000 | Size for 100 |
|---|---|---|---|
| Model | | products and | products and 25 |
| Charac- | | 25 locations | locations and |
| teristics | Formula | and 200 grids | 200 grids |
| Number of | I + J + K + 1 | 1,226 | 326 |
| rows | | | |
| Upper bound | I * (J + 1) + J * K | 31,000 | 7,600 |
| on number of | | | |
| columns | | | |
| Upper bound | I * J | 25,000 | 2,500 |
| on nonzero | | | |
| objective | | | |
| function | | | |
| entries | | | |

The variables and constants in the above table are the same as in Table 3, with K representing the number of grid locations.

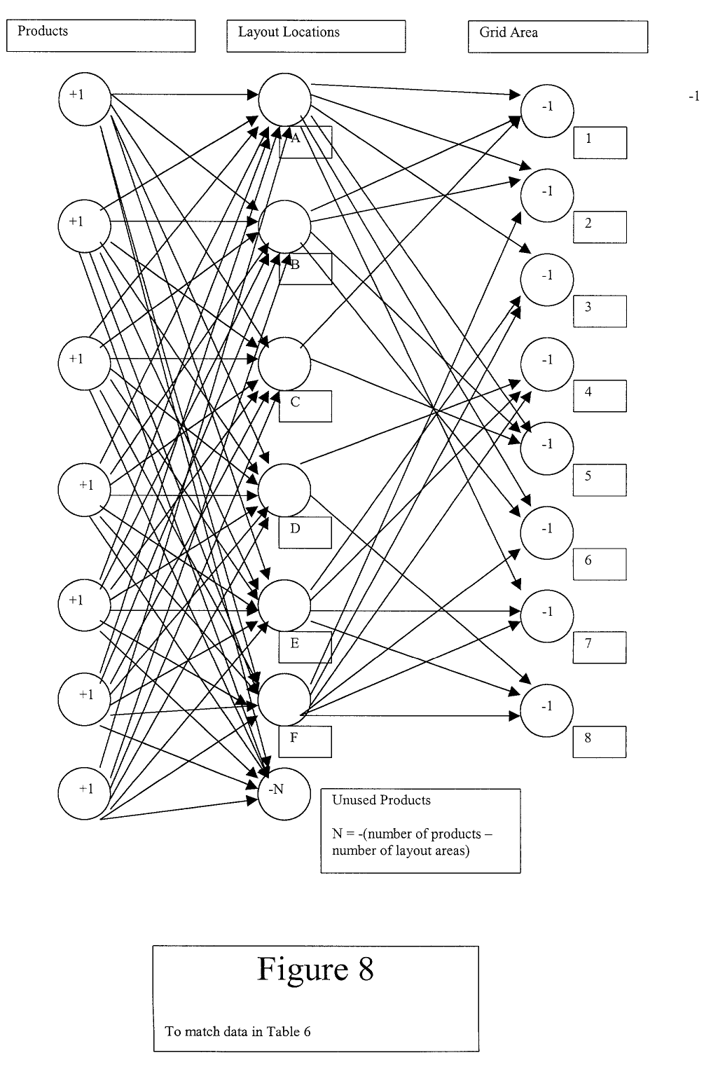

Referring to FIG. 8, a flow diagram illustrating the network model is depicted in accordance with the present invention. Each product node has a supply of +1, and each grid area has a demand of −1. The products flow to the location along the route that maximizes profit. Because each layout location uses several underlying grid locations, a product flowing to a layout location must “grab” each grid area used by the layout location to prevent layout areas from using the same grid (overlapping). To implement this,

Each product to layout location arc is defined with a +1 and a −m in the arc column, where m is the number of grid areas used by the layout location

Each layout location to grid area arc is defined with a +1 and −1 in the arc column

No more than one product can flow to a particular layout location. Products that are not selected would flow to the unused location. The cost for each product-to-layout location arc in the network is:

(probability of product purchase)×(profit per purchase)×(preference of location)

The cost for each layout location-to-grid area is 0. The arc costs and arc multipliers have been omitted from FIGS. 8 to improve the clarity of the figure.

For example, a layout area that uses grids 1, 2, 5, and 6 above would have a +1 and −4 as column entries in the node-arc incidences matrix.

The present invention allows marketing businesses to increase the number of customized mailings (whether paper or electronic) without an increase in design staff support. The invention also enables marketers to increase the number of niche markets (or individuals) that can be addressed and maximizes the profit per customer.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for customizing direct marketing materials, comprising:
developing models to predict customer purchases;
scoring customers for each predictive model;
determining specific layout areas;
determining where a particular product can be placed in the layout; and
using an optimization model to customize the layout for customers.

2. The method according to claim 1, wherein the step of determining specific layout areas further comprises determining the maximum and minimum possible sizes for each product layout.

3. The method according to claim 1, wherein the step of determining specific layout areas further comprises determining a preference multiplier for each layout area.

4. The method according to claim 1, further comprising passing the optimization model output to a print manager for printing only if the expected profit exceeds the production cost of the customized layout.

5. The method according to claim 1, wherein the optimization model used to customize the layout is a transportation model.

6. The method according to claim 1, wherein the optimization model used to customize the layout is a network model.

7. The method according to claim 1, wherein the optimization model used to customize the layout is a generalized network model.

8. The method according to claim 1, wherein the customization is directed at a niche market.

9. The method according to claim 1, wherein the customization is directed at individual customers.

10. A computer program product in a computer readable medium for use in a data processing system for customizing direct marketing materials, the computer program product comprising:
instructions for developing models to predict customer purchases;
instructions for scoring customers for each predictive model;
instructions for determining specific layout areas;
instructions for determining where a particular product can be placed in the layout; and
instructions for using an optimization model to customize the layout for customers.

11. The computer program product according to claim 10, wherein the instructions for determining specific layout areas further comprises instructions for determining the maximum and minimum possible sizes for each product layout.

12. The computer program product according to claim 10, wherein the instructions for determining specific layout areas further comprises instructions for determining a preference multiplier for each layout area.

13. The computer program product according to claim 10, further comprising instructions for passing the optimization model output to a print manager for printing only if the expected profit exceeds the production cost of the customized layout.

14. The computer program product according to claim 10, wherein the optimization model used to customize the layout is a transportation model.

15. The computer program product according to claim 10, wherein the optimization model used to customize the layout is a network model.

16. The computer program product according to claim 10, wherein the optimization model used to customize the layout is a generalized network model.

17. The computer program product according to claim 10, wherein the customization is directed at a niche market.

18. The computer program product according to claim 10, wherein the customization is directed at individual customers.

19. A system for customizing direct marketing materials, comprising:
means for developing models to predict customer purchases;
means for scoring customers for each predictive model;
means for determining specific layout areas;
means for determining where a particular product can be placed in the layout; and
means for using an optimization model to customize the layout for customers.

20. The system according to claim 19, wherein the means for determining specific layout areas further comprises means for determining the maximum and minimum possible sizes for each product layout.

21. The system according to claim 19, wherein the means for determining specific layout areas further comprises means for determining a preference multiplier for each layout area.

22. The system according to claim 19, further comprising means for passing the optimization model output to a print manager for printing only if the expected profit exceeds the production cost of the customized layout.

23. The system according to claim 19, wherein the optimization model used to customize the layout is a transportation model.

24. The system according to claim 19, wherein the optimization model used to customize the layout is a network model.

25. The system according to claim 19, wherein the optimization model used to customize the layout is a generalized network model.

26. The system according to claim 19, wherein the customization is directed at a niche market.

27. The system according to claim 19, wherein the customization is directed at individual customers.
